(19) United States
(12) Patent Application Publication
(10) Pub. No.: US 2018/0341218 A1
(43) Pub. Date: Nov. 29, 2018

(54) IMAGE FORMING APPARATUS

(71) Applicant: CANON KABUSHIKI KAISHA, Tokyo (JP)

(72) Inventors: Makoto Adaniya, Matsudo-shi (JP); Satoshi Murasaki, Numazu-shi (JP); Hiroyuki Yamano, Susono-shi (JP)

(21) Appl. No.: 15/987,124

(22) Filed: May 23, 2018

(30) Foreign Application Priority Data
May 25, 2017 (JP) 2017-103432

(51) Int. Cl. G03G 21/20

(52) U.S. Cl. CPC G03G 21/206; G03G 2215/00421

(57) ABSTRACT

An image forming apparatus includes an image fixing device having a nip; an air blower for feeding air for cooling a first area which is an end portion area, in a longitudinal direction of the fixing device, of the nip; a blocking member for changing a width of an opening through which the air flows; a first blow portion through which the air toward the opening; a second blow portion through which the air from the air blowing device toward a second area which is a region in a widthwise direction of the sheet passed through the nip flows; and a third blow portion through which the air from the air blower toward a third area which is closer to an end in the widthwise direction flows. The third blow portion is disposed at a position to take the air blocked by the blocking member.

### FIELD OF THE INVENTION AND RELATED ART

The present invention relates to an image forming apparatus such as a copying machine and a printer, which employs an electrophotographic image forming method, an electrostatic image recording method, or the like.

In an image forming apparatus, an unfixed toner image is fixed to a sheet of recording medium. As a method for fixing an unfixed toner image to a sheet of recording medium, a thermal fixing method has been widely known, which melts the toner particles, of which an unfixed toner image is formed, by heating the unfixed toner image. If a substantial number of sheets of recording medium, which are narrower than the widest sheet of recording medium conveyable through a fixing apparatus which employs the thermal fixing method, are conveyed through the fixing apparatus in succession, the out-of-sheet-path portions of the rotational fixing member of the fixing apparatus (portions of rotational fixing member, which are outside recording medium path) excessively increase in temperature, which in turn possibly causes the toner on the sheet of recording medium to offset (hot offset), and/or the structural components of the apparatus to deteriorate.

In the case of the fixing apparatus disclosed in Patent Document 1, it is provided with a shutter unit made up of a combination of a fan and shutters. It is structured so that the shutters are movable in the lengthwise direction of the fixing apparatus, according to the size (width) of a sheet of recording medium in terms of the lengthwise direction of the apparatus, making it possible for the cooling air outlet to be adjusted in dimension in terms of the lengthwise direction of the fixing apparatus, in order to prevent the out-of-sheet-path portions of the fixing apparatus from undesirably increasing in temperature, regardless of sheet size.

As an image forming apparatus is increased in speed, it sometimes occurs that when two (or more) prints are continuously produced, the following print is discharged into a delivery tray before the preceding print in the delivery tray cools down, and therefore, the adhesiveness of the melted toner on the sheet of the preceding print causes the two sheets to adhere to each other. As for the technology to prevent two consecutively made prints from being adhered to each other by the melted toner, it has been known to employ a fan to air-cool each print (sheet of recording medium) as it comes out of a fixing device.

According to some of the conventional technologies which employ a fan to air-cool a print (sheet of recording medium) as the print comes out of a fixing device, an image forming apparatus is structured so that a shutter can be positioned (partially opened) to block a part of the airflow generated by the fan (Japanese Laid-open Patent Application No. 2008-003141. This structural arrangement, however, has not been successful to efficiently utilize the airflow provided by the fan.

Further, providing an image forming apparatus with an additional fan to cool each sheet of recording medium as the sheet is discharged into a delivery tray suffers a problem similar to the problem described above.

Therefore, the primary object of the present invention is to provided an image forming apparatus which can not only prevent the portions of a fixing member, which are outside the recording medium path, from undesirably increasing in temperature, but also, efficiently cool a sheet of recording medium as the sheet is discharged into a delivery tray, regardless of its size in terms of the lengthwise direction of the fixing device.

### SUMMARY OF THE INVENTION

According to an aspect of the present invention, there is provided an image forming apparatus comprising an image forming portion configured to form an image on a recording material; a fixing device having a nip configured to fix the image on the recording material while nipping and feeding the recording material carrying the image; air blowing means configured to feed air for cooling a first area which is an end portion area, with respect to a longitudinal direction of said fixing device, of a fixing member constituting said nip; a blocking member configured to change a width of an opening through which the air fed by said air blowing means flows; a first blow portion through which the air fed by said air blowing means toward the opening; a second blow portion through which the air from said air blowing means toward a second area which is a region in a widthwise direction of the recording material passed through said nip flows; and a third blow portion through which the air from said air blowing means toward a third area which is closer to an end in the widthwise direction of the recording material passed through said nip flows, wherein said third blow portion is disposed at a position to take the air blocked by said blocking member.

Further features of the present invention will become apparent from the following exemplary embodiments with reference to the attached drawings.

### BRIEF DESCRIPTION OF THE DRAWINGS

FIG. 1 is a sectional view of the image forming apparatus in one of the preferred embodiments of the present invention.

FIG. 2 is a sectional view of the fixing apparatus mounted in the image forming apparatus shown in FIG. 1; it is for showing the general structure of the fixing apparatus.

Part (a) of FIG. 3 is a schematic front view of the fixing mechanism portion of the fixing apparatus show in FIG. 2, and part (b) of FIG. 3 is a schematic sectional view of the fixing mechanism portion of the fixing apparatus, at the vertical plane which coincides with the axial line of the pressure roller of the fixing apparatus, as seen from the front side of the apparatus.

FIG. 4 is a block diagram of the control system of the image forming apparatus.

FIG. 5 is a schematic drawing of a combination of the delivery tray of the image forming apparatus shown in FIG. 1, and the airflow (air paths) in the tray.

FIG. 6 is a schematic drawing of the shutter unit, as seen from the fixing apparatus side, when the shutter is completely shut.

FIG. 7 is a schematic drawing of the shutter unit, as seen from the fixing apparatus side, when the shutter is open.

FIG. 8 is a schematic drawing of the shutter unit, as seen from the delivery tray side, when the shutter is open.

FIG. 9 is a schematic sectional view of a combination of the fixation mechanism portion, shutter unit, and a part of the delivery tray, at a plane which is perpendicular to the direction Z in FIG. 8, when the shutter is completely shut; it shows the airflow (air paths) from the delivery tray to the fixing apparatus.

FIG. 10 is a schematic sectional view of a combination of the fixation mechanism portion, shutter unit, and a part of the delivery tray, at a plane A-A in FIG. 9.

FIG. 11 is a schematic sectional view of the combination in FIG. 9, at a plane B-B in FIG. 9.

FIG. 12 is a schematic sectional view of the combination in FIG. 9, at a plane C-C in FIG. 9.

FIG. 13 is a schematic sectional view of the combination in FIG. 9, at a plane D-D in FIG. 9.

FIG. 14 is a schematic horizontal sectional view of the combination of the fixing mechanism portion, shutter unit, and a part of the delivery tray, when the shutter is fully open; it shows the airflow (air paths) from the delivery tray to the fixing apparatus.

FIG. 15 is a schematic sectional view of the combination in FIG. 14, at a plane E-E in FIG. 14.

FIG. 16 is a schematic horizontal sectional view of a combination of the fixation mechanism portion, shutter unit, and a part of the delivery tray, at a plane which is perpendicular to the direction Z, when the shutter is remaining completely closed; it shows the airflow (air paths) from the delivery tray to the fixing apparatus.

FIG. 17 is a schematic sectional view of the combination in FIG. 16, at a plane F-F in FIG. 16.

### DESCRIPTION OF THE EMBODIMENTS

Hereinafter, the present invention is described in detail with reference to the appended drawings related to one of its preferred embodiments.

### Embodiment 1

### Image Forming Apparatus

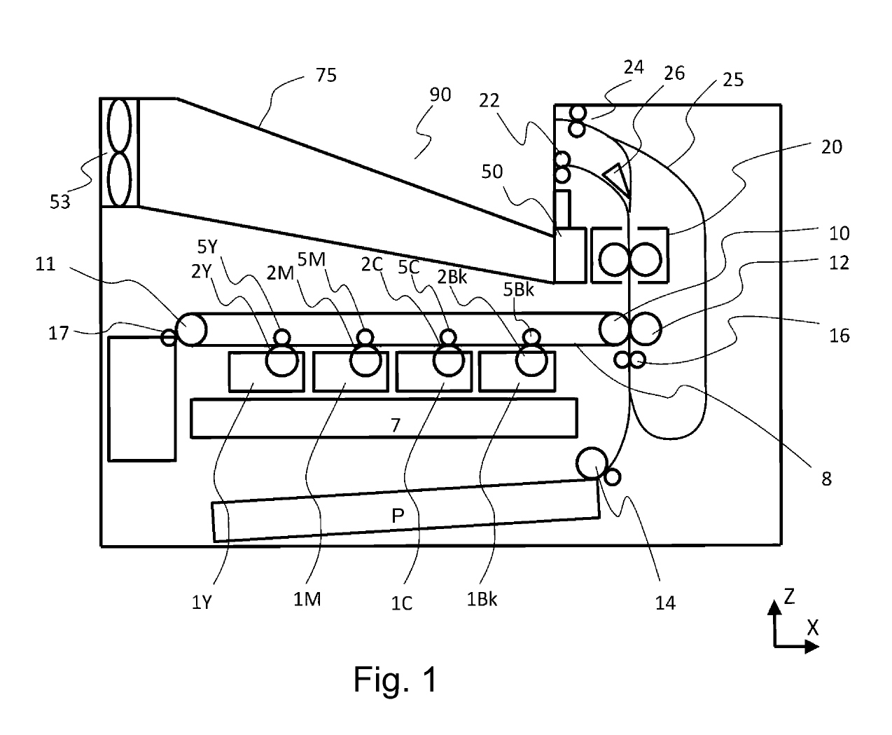

To begin with, referring to FIG. 1, the image forming apparatus in one of the preferred embodiments of the present invention is described about its overall structure. This image forming apparatus is a color laser-beam image forming apparatus, more specifically, a full-color laser-beam printer. FIG. 1 is a vertical sectional view of the printer 90. It shows the overall structure of the apparatus. The full-color laser-beam printer 90 has a sheet feeding means 14, which is in the bottommost portion of the printer 90. The printer 90 has also a registration roller unit 16, which is for registering each sheet P of recording medium. The registration roller unit 16 is on the top-right side of the sheet feeding means 14.

The printer 90 is structured so that four process cartridges 1 (1Y, 1M, 1C and 1Bk) can be installed above the sheet-feeding means 14. The four process cartridges 1 are provided with four photosensitive drums 2 (2Y, 2M, 2C and 2Bk), respectively. Further, the printer 90 is provided with an intermediary transfer unit, which is on the top side of the space for the process cartridges 1 (1Y, 1M, 1C and 1Bk). The intermediary transfer unit is provided with an intermediary transfer belt 8. Moreover, the printer 90 is provided with primary transfer rollers 5 (5Y, 5M, 5C and 5Bk), which are on the inward side of the loop (belt loop) which the intermediary transfer belt 8 forms. Further, the printer 90 is provided with a belt-backing roller 10 and a tension roller 11, which are also on the inward side of the belt loop. Further, the printer 90 is provided with a cleaning means 17 for cleaning the intermediary transfer belt 8.

Moreover, the printer 90 is provided with a secondary transfer unit, which is on the right side of the intermediary transfer unit. The secondary transfer unit is provided with a secondary transfer roller 12, which opposes the belt-backing roller 10, with the presence of the intermediary transfer belt 8 between itself and belt-backing roller 10. There is a fixation mechanism portion 20 (fixation unit) on the top side of the secondary transferring portion which comprises the secondary transfer roller 12 and belt-backing roller 10. Further, the printer 90 is provided with a pair of discharge rollers 22 (which makes up sheet-discharging unit), a sheet passage 25 for two-sided image formation mode, a pair of reversal conveyance rollers 24, and a sheet-guiding flapper 26 as a sheet-directing means. The discharge rollers 22, sheet passage 25, reversal conveyance rollers 24, and flapper 26 are on the top-left side of the fixation mechanism portion 20.

The printer 90 is structured so that as a sheet P of recording medium comes out of the fixation nip of the fixation mechanism portion 20, it is conveyed to a delivery tray 75, through a sheet passage which is adjacent to a cooling fan (cooling blowing means) 53 as an air-blowing means. By the way, a shutter unit 50 as a airflow-blocking member, and the cooling fan 53, which are shown in FIG. 1, are described later in detail.

### Fixing Apparatus

### 1) Fixation Mechanism Portion

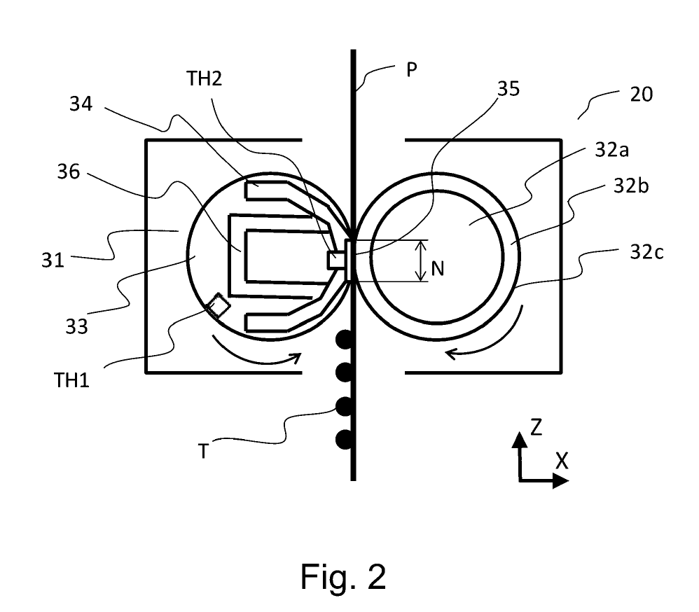

FIG. 2 is a sectional view of the fixing apparatus (fixing device) mounted in the image forming apparatus in this embodiment of the present invention. It shows the general structure of the fixation mechanism portion 20 of the fixing apparatus. Part (a) of FIG. 3 is a schematic front view of the fixation mechanism portion 20. Part (b) of FIG. 3 is a schematic vertical sectional view of the fixation mechanism portion 20, at a vertical plane which coincides with the axial line of the pressure roller. In the following description of the image forming apparatus in accordance with the present invention, the “lengthwise direction” means the direction which is perpendicular to both the recording medium conveyance direction and the thickness direction of the recording medium. Regarding a sheet of recording medium, the “widthwise direction” means the direction which corresponds to the “lengthwise” direction of the fixing member, that is, the “lengthwise direction” of the fixing apparatus.

The fixing mechanism portion 20 is a part of a fixing apparatus which is of the so-called on-demand type. It is structured to heat a sheet of recording medium and the image thereon through a belt (film), and drive a rotational pressure-applying roller. Referential codes 31 and 32 in the drawings stand for a film assembly as the first fixing member (heating member), and an elastic pressure roller as the second fixing member (pressure applying member), respectively. The two fixing members are kept pressed against each other to form a fixation nip N, through which a sheet of recording medium, which is bearing a toner image, is conveyed while remaining pinched between the two fixing members.

Regarding the film assembly 31, a referential code 33 stands for a fixation film (first rotational member, film), which is a rotational heating member. The fixation film 33 is cylindrical (endless belt; belt in the form of sleeve), and is flexible. Designated by a referential code 34 is a film guide (heater-holding member, which functions also as film-guiding member), which is in the form of a trough which is semicircular in cross-section. The film guide 34 is heat resistant and rigid. Designated by a referential code 35 is a ceramic heater (which hereafter is referred to simply as heater) as a heat source (heating member). The heater 35 is fixed to the film guide 34 by being fitted in a groove with which the film guide 34 is provided. The groove is roughly U-shaped in cross-section and extends in the lengthwise direction the film guide 34. The film 33 is loosely fitted around the film guide 34, by which the heater 35 is held.

Referring to parts (a) and (b) of FIG. 3, a referential code 36 stands for a pressure stay, which is rigid; U-shaped in cross-section; and on the inward side of the film guide 34. A referential code 36a stands for the lengthwise end portions (left and right end portions) of the pressure stay 36. A referential code 37 stands for each of a pair of end holders, with which the lengthwise end portions (arm portions) of the pressure stay 36 are fitted. A referential code 37a stands for each of a pair of integral flange portion of the holder 37. The fixing apparatus is structured so that the film assembly 31 is parallel to the pressure roller 32 (second rotational member), and the heater side of the film assembly 31 faces the pressure roller 32 (second rotational member). Further, there are provided a pair (left and right) of compression springs 40, between the left and right end holders 37, and a pair (left and right) spring seats 39, respectively. The pair of compression springs 40 are kept compressed.

Thus, a combination of the pressure stay 36, film guide 34, and heater 35 remains pressed toward the pressure roller 32. Therefore, the heater 35 remains pressed against the pressure roller 32 by the pressure generated by the pair of compression springs 40, with the presence of the film 33 between the heater 35 and pressure roller. Thus, the fixation nip N, which is necessary for thermal fixation, and has a preset width in terms of the recording medium conveyance direction, is formed between the film 33 and pressure roller 32.

As a sheet P of recording medium is introduced into the fixation nip N, the sheet P is conveyed by the rotating pressure roller 32 while remaining pinched between the pressure roller 32 and film 33. In this embodiment, the fixing apparatus is structured so that when the sheet P is conveyed through the fixing apparatus (image forming apparatus), the center of the sheet P, in terms of the widthwise direction, coincides with center of the fixing apparatus (image forming apparatus). That is, the apparatus is structured so that when a sheet P of recording medium is conveyed through the fixing apparatus (image forming apparatus), the center of the sheet P, in terms of the widthwise direction, coincides with the widthwise center of the film 33, regardless of sheet width. Referring to part (a) of FIG. 3, a referential code S stands for the referential centerline (hypothetical line) in terms of the widthwise direction of the sheet P.

Referring to parts (a) and (b) of FIG. 3, designated by a referential code W1 is the path of the widest sheet of recording medium conveyable through the fixing apparatus. In this embodiment, the path W1 is 320 mm in width, which corresponds to the width of a sheet S of recording medium of size A3 (SRA3 in portrait mode). The width A of the heat generation range of the heater 35, in terms of the lengthwise direction, is slightly wider than the path W1. A referential code W3 stands for the path of the narrowest sheet P of recording medium conveyable through the fixing apparatus. In this embodiment, the width of the path W3 is 100 mm, which corresponds to the width of a postcard (postcard in portrait mode).

A referential code W2 stands for the path of a sheet P of recording medium, the width of which is between the widest and narrowest sheets of recording medium conveyable through the fixing apparatus. In this embodiment, the sheet path W2 is 279.4 mm wide, which corresponds to the width of a LTR size sheet P of recording medium (LTR in landscape mode). Hereafter, a sheet of recording medium, the width of which corresponds to the widest sheet path W1 is referred to as the largest sheet of recording medium, whereas a sheet P of recording medium, which is narrower than the largest sheet of recording medium is referred to as a small sheet P of recording medium.

A referential code a stands for the area between one of the edges of the path W1 of the largest sheet, and the corresponding edge of the path W2 of a sheet of recording medium of the intermediary size (a=(W1−W2)/2). A referential code b stands for the area between one of the edges of the path W1 of the widest sheet of recording medium conveyable through the fixing apparatus, and the corresponding edge of the path W3 of the narrowest sheet P of recording medium conveyable through the fixing apparatus (b=(W1−W3)/2. That is, they stand for the out-of-sheet-path portions, which occur as a sheet of recording medium which is smaller in width than the widest sheet of recording medium conveyable through the fixing apparatus, for example, a sheet of recording medium of a size B4, A5, or the like, is conveyed through the fixing apparatus. In this embodiment, the fixing apparatus (image forming apparatus) is structured so that when a sheet of recording medium is conveyed, the widthwise center line of the sheet coincides with the widthwise centerline of the recording medium passage. Therefore, the out-of-sheet-path portions a and b occur on both sides of the paths W2 and W3, in terms of the widthwise direction. The width of the out-of-sheet-path portion is affected by the width of a sheet of recording medium conveyed through the fixing apparatus (image forming apparatus).

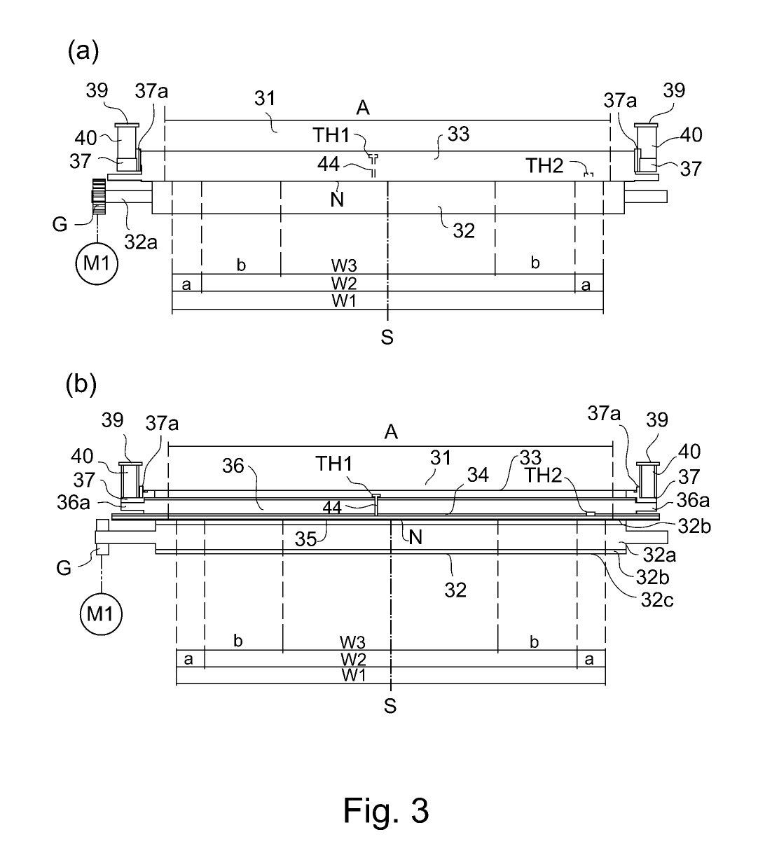

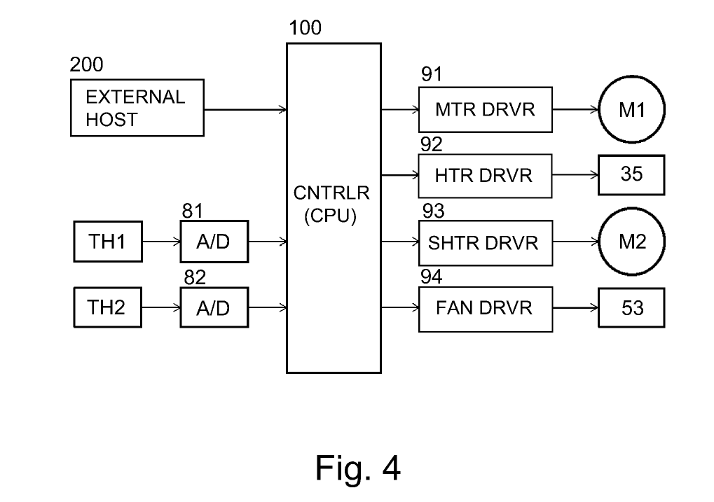

Referring to FIG. 4, as the heat generating layer, with which the substrate of the heater with is provided, is supplied with electric power by a heater-driving circuit 92 as an electric power supplying portion, the heater 35 quickly increases in temperature across the entirety of its heat generation range in terms of the lengthwise direction. The temperature of the film 33 is detected by a main thermistor TH1, and the temperature of the heater 35 is detected by a sub-thermistor TH2. Based on the outputs of the main thermistors TH1 and sub-thermistor TH2, the control portion decides how the fixation heater 35 is to be controlled in temperature, and controls the electric power supply from the heater-driving circuit 92 to the fixation heater 35.

The control circuit portion 100 drives a fixation motor M1 while controlling a fixation-motor-driving circuit 91 based on the print signals from an external host apparatus, or other control signals. Thus, the pressure roller 32 is rotationally driven. Therefore, the film 33 is rotated by the rotation of the pressure roller 32. Further control circuit portion 100 controls the heater-driving circuit 92 to make the heater 35 increase in temperature.

As the film 33 becomes stable in rotational speed, and the heater 35 becomes stable in temperature at a preset level, a sheet P of recording medium, which is bearing an unfixed toner image, is introduced into the fixation nip N, from the image forming portion side of the fixing apparatus, in such an attitude that the toner image bearing surface of the sheet P faces the film 33. While the sheet P is conveyed through the fixation nip N, the film 33 moves with the sheet P, and the sheet P is kept pressed against the pressure roller 32 by the fixation mechanism portion 20, with the presence of the film 33 between the sheet P and heater 35.

While the sheet P is conveyed through the fixation nip N, heat is given to the sheet P from the film 33, which is being heated by the heater 35. Further, the sheet P and the toner image T thereon are subjected to the fixation nip pressure. Thus, the toner image T becomes fixed (thermal fixation) to the surface of the sheet P. After being conveyed through the fixation nip N, the sheet P is separated from the surface of the film 33, and is conveyed further to be discharged from the image forming apparatus.

### 2) Cooling Mechanism Portion

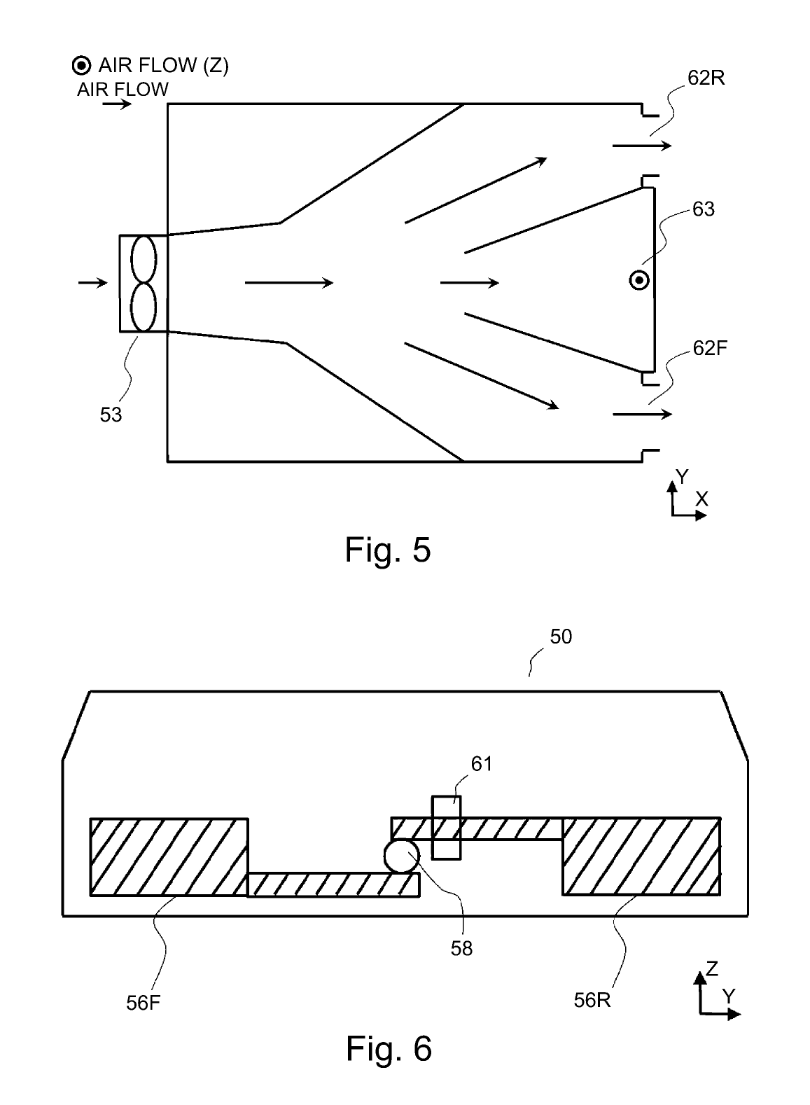

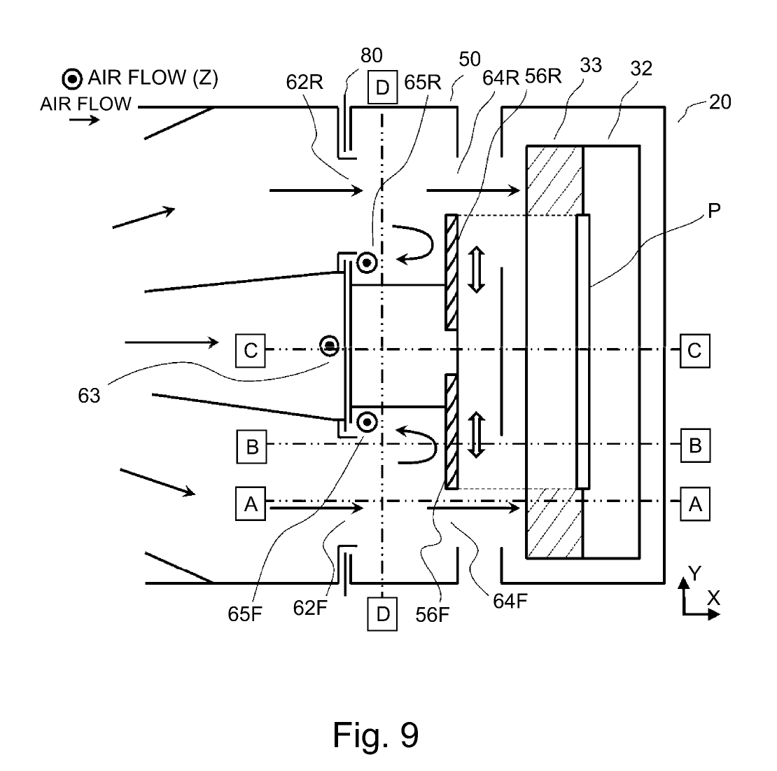

Next, the mechanism portion of the image forming apparatus in this embodiment, which is for cooling the fixing apparatus in the image forming apparatus, is described about its portion for cooling the lengthwise end portions of the fixing apparatus, and its portion for cooling a sheet of recording medium as the sheet comes out to be discharged into the delivery tray of the image forming apparatus. FIG. 5 is a schematic drawing of the cooling air paths in the delivery tray 76. FIG. 9 is a schematic sectional view of a combination of the fixation mechanism portion, shutter unit, and a part of the delivery tray, at a plane which is perpendicular to the direction Z in FIG. 8, when the shutter is completely shut. It shows the airflow (air paths) from the delivery tray to the fixing apparatus. The body of cooling air from the cooling fan 53 is sent into the delivery tray 75. Then, it is separated into three bodies of airstream by the divider ribs provided in the delivery tray 75.

Referring to FIG. 9, a front opening 62F, shown in FIG. 5, is in connection to the air passage from the cooling fan 53 to the shutter unit 50. A center opening 63, shown in FIG. 5, is positioned so that the air from the cooling fan 53 flows in the directions X and Y, which are perpendicular to the direction Z (which is perpendicular to FIG. 9). Referring also to FIG. 9, a rear opening 62R, shown in FIG. 5, is in connection to the air passage from the cooling fan 53 to the shutter unit 50.

In this embodiment, the front and rear openings 62F and 62R function as a pair of first air outlets, through which the air (wind) from the cooling fan 53 flows to the first area of the fixing member in terms of the lengthwise direction. The central opening 63 functions as the second air outlet, through which the air (wind) from the cooling fan 53 flows to the second area (central area) of a sheet of recording medium, in terms of the widthwise direction of the sheet.

In this embodiment, the direction in which the air (wind) from the cooling fan 53 flows through the second air outlet, and the third air outlet (air flows to third area, which is on the outer side of second area, in terms of widthwise direction of sheet of recording medium), is such a direction that is intersectional (perpendicular) to the direction in which the air flows through the first air outlet. Further, each of the air passage from the cooling fan 53, as an airflow generating means, to the first air outlet, and the air passage from the cooling fan 53 to the third air outlet, branches.

Next, the shutter unit 50 is described. The shutter unit 50 in this embodiment is provided with a blocking member, which not only blocks the area other than the first areas, to form the first areas, which are the lengthwise end portions of the film 33, but also, changes the openings in dimension according to the size of a sheet of recording medium in terms of the widthwise direction of the sheet.

FIG. 6 is a schematic drawing of the shutter unit 50, as seen from the fixation mechanism portion side, when the shutter is open. The shutter unit 50 is provided with the front and rear shutters 56F and 56R, which are movable in the front-rear direction (Y/−Y direction) by the driving force inputted through a pinion gear 58 which is in connection to a shutter motor M2. The amount by which the shutter is open is sensed by a sensor 61.

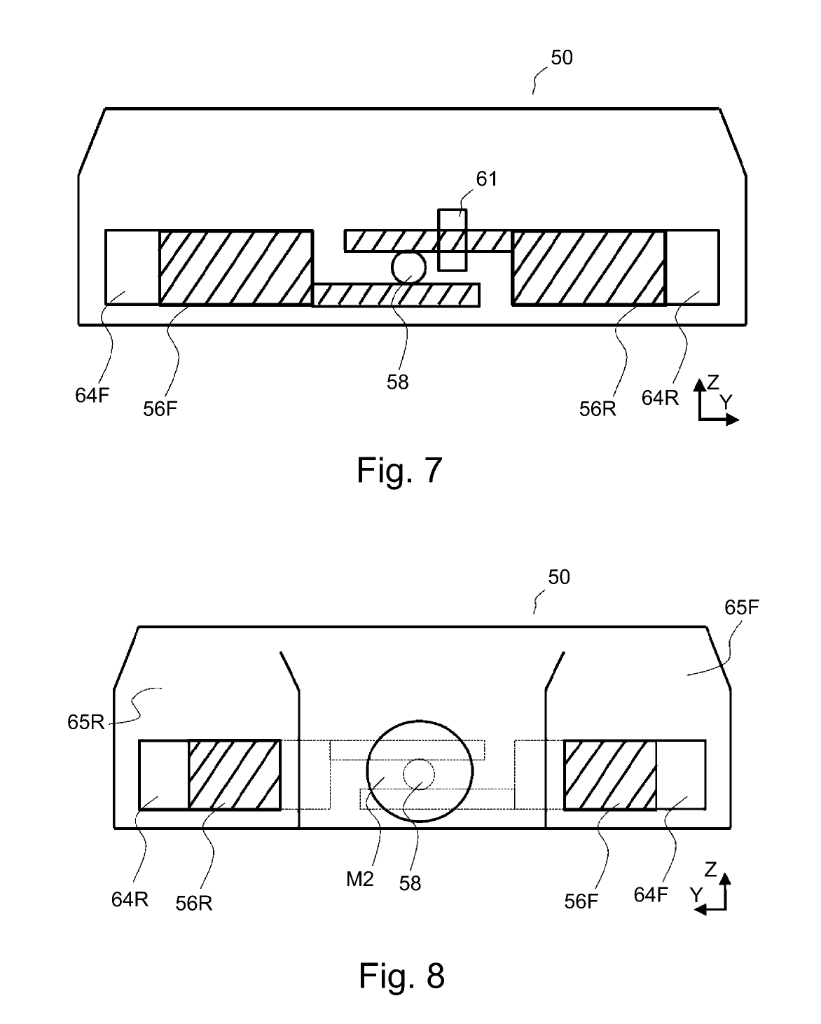

FIG. 7 is a schematic drawing of the shutter unit 50, as seen from the fixation mechanism portion side, when the shutter is open by a preset amount, unlike FIG. 6. When the shutter unit 50 is in the state shown in FIG. 7, the front and rear openings 64F and 64R, respectively, have been widened by the movement of the rear shutters 56F and 56R, making it possible for the air to flow through the openings 64F and 64R.

FIG. 8 is a schematic drawing of the shutter unit 50, as seen from the opposite side (delivery tray side) of the shutter unit 50, when the shutter unit 50 is in the state shown in FIG. 7. In terms of the lengthwise direction, the shutter unit 50 has three sections. The first section, or the right section (front side of main assembly of fixing apparatus) in FIG. 8, is in connection to the front opening 62F (FIG. 9) of the delivery tray 75 (FIG. 1). There is an opening above the first section (in direction Z); there is an opening 65F for cooling a sheet of recording medium before the sheet is discharged into the delivery tray 75. The opening 65F is on lengthwise end side of the central opening 63. The center section, or the center portion (of main assembly of fixing apparatus) in the drawing, is provided with the shutter motor M2 (FIG. 8).

Further, the third section, or the left portion of the shutter unit 50 in FIG. 8, is in connection to the rear opening 62R (FIG. 9) of the delivery tray 75. There is an opening above the third section; there is opening 65R for cooling a sheet of recording medium before the sheet enters the delivery tray 75. In this embodiment, the opening 65F and 65R function as the third air outlets through which the air (wind) from the cooling fan 53 flows.

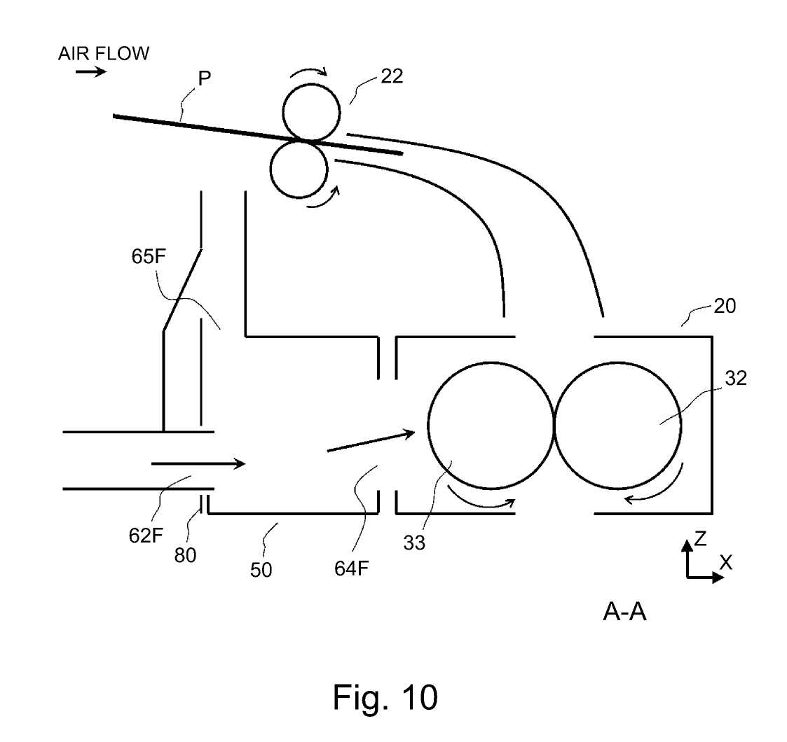

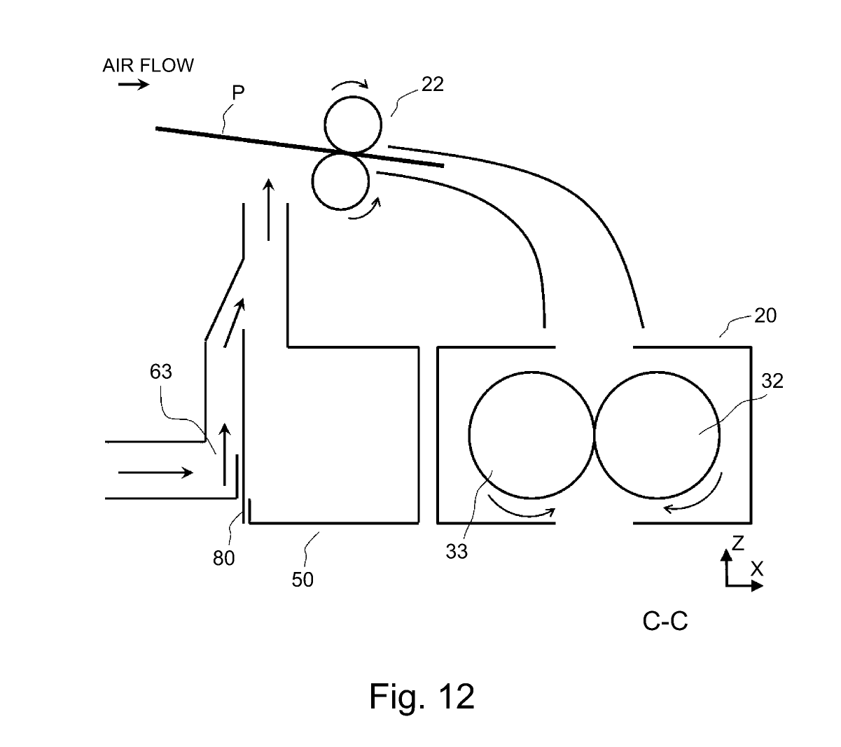

FIGS. 10-13 are schematic sectional views of a combination of the fixation mechanism portion, shutter unit, and a part of the delivery tray, at planes A-A, B-B, C-C and D-D in FIG. 9. The size of each opening of the shutter unit 50 corresponds to the state in which a sheet of recording medium of the LTR size is conveyed in the landscape mode (recording medium dimension is 279.4 mm in width). Referring to FIGS. 9 and 10, the airflow for cooling the front side of one (front side) of the widthwise end portions of the film 33 (first rotational member), as the fixing member, which faces toward the cooling fan 53 (FIG. 1), is described.

As the cooling air is sent into the delivery tray 75 by the cooling fan 53, it is sent to the shutter unit 50 through the front opening 62F of the delivery tray 75. When the abovementioned combination of the fixation mechanism portion, shutter unit, and a part of the delivery tray is in the state shown in FIGS. 9 and 10, the front shutter 56F has been moved by a preset amount. Therefore, the front opening 64F is unblocked. Therefore, the cooling air is allowed to blow on the film 33 through the front opening 64F, to cool the front end portion (out-of-sheet-path portion) of the film 33 (first rotational member) in terms of the lengthwise direction.

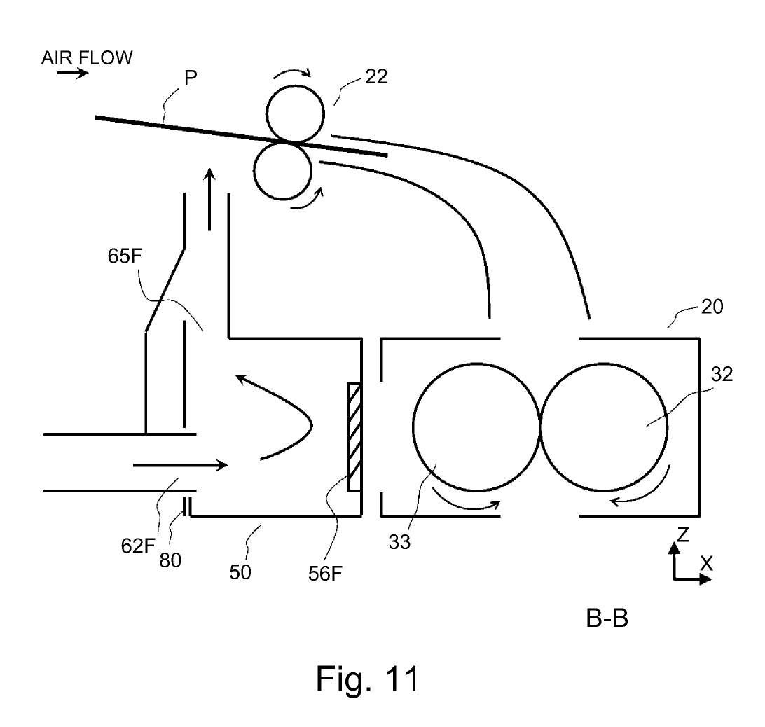

Referring again to FIG. 9, as a body of air flows into the delivery tray 75 through the front opening of the tray, a part of it is blocked by the front shutter 56F, but, the rest is guided into the front opening 65F of the shutter unit 50. That is, the front opening 65 is in the position in which it accommodates the body of air which came through the front opening 62F. Therefore, the portion of the body of air blocked by the front shutter 56F is blown through the opening 65F (FIG. 11) provided above the shutter unit 50, toward the front end portion of a sheet P of recording medium, in terms of the widthwise direction, and cools the sheet P, as the sheet P is discharged into the delivery tray 75 by the pair of discharge rollers 22.

The path of the airflow for cooling the rear end portion of the fixing member in terms of the lengthwise direction is symmetrical to the path of the airflow for cooling the front end portion of the fixing member in terms of the lengthwise direction, with reference to the centerline of the main assembly of the image forming apparatus (fixing apparatus). That is, referring to FIG. 9, as a body of air flows into the shutter unit 50 through the rear opening 62R of the delivery tray 75, a part of it is blocked by the rear shutter 56R, but, the rest is made to flow toward the rear opening 65R with which the shutter unit 50 is provided. That is, the shutter unit 50 is structured so that its opening 65R is positioned to take in the portion of the airflow which was not blocked by the rear shutter 56R. Therefore, the portion of the airflow blocked by the rear shutter 56R is made to blow at the rear end portion of the sheet P of recording medium, through the opening 65R, cooling thereby the sheet P, as the sheet P is discharged by the pair of discharge rollers 22 (FIG. 1).

As for the body of cooling air which flows through the lengthwise center portion of the delivery tray 75, it flows upward (in direction Z) of the main assembly, through the central opening 63 (FIG. 9). Then, it advances through the space between the delivery tray 75 and the frame 80 of the main assembly of the image forming apparatus. Thus, it blows upon the center portion of a sheet P of recording medium, in terms of the widthwise direction, as the sheet P is discharged by the pair of discharge rollers 22. Thus, it can cool the center portion of the sheet P.

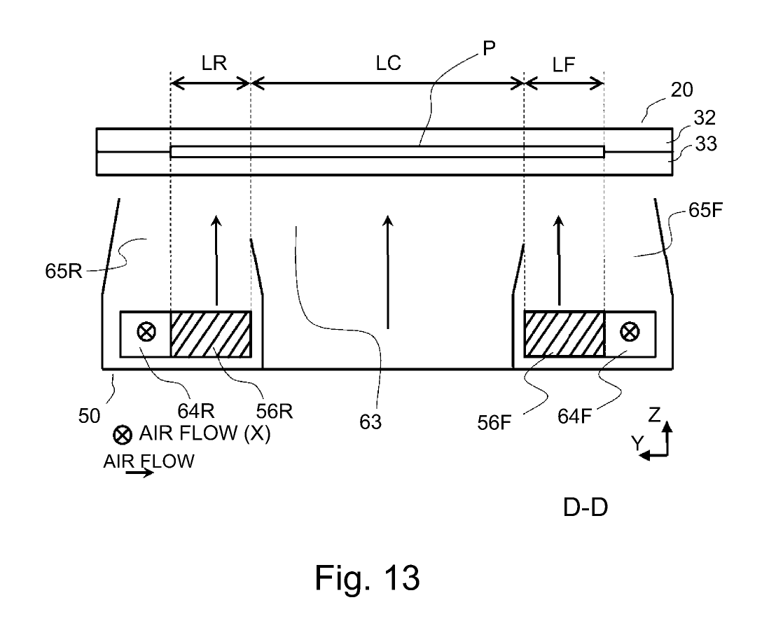

FIG. 13 is a schematic sectional view of a combination of the pressure roller 32, film 33, and shutter unit 50, at a plane X, or a plane which is perpendicular to the direction X. It shows how and where the cooling air hits a sheet P of recording medium as the sheet P is discharged by the pair of discharge rollers 22 (FIG. 1). As described above, when the shutter unit 50 is in the state shown in FIG. 13, the front shutter 56F and rear shutter 56R are in their positions into which they have been moved to accommodate a sheet P of recording medium of the LTR size (279.4 mm in landscape mode). Thus, the cooling air flows toward the end portions of the film 33 (in plane X) in terms of the lengthwise direction, through the front opening 64F and rear opening 64R.

As for a part of the body of cooling air, which was blocked by the front shutter 56F and rear shutter 56R, it flows toward the sheet P through the front opening 65F and rear opening 65R. Further, the cooling air flows to the sheet P through the central opening 63. Thus, there is the following relationship among an area LF, in which the sheet P is cooled by the cooling air discharged through the front opening 65F, an area range LC in which the sheet P is cooled by the cooling air discharged through the central opening 63, and an area LR, in which the sheet P is cooled by the cooling air discharged through the rear opening 65R:

LF+FR+LC=279.4 mm.

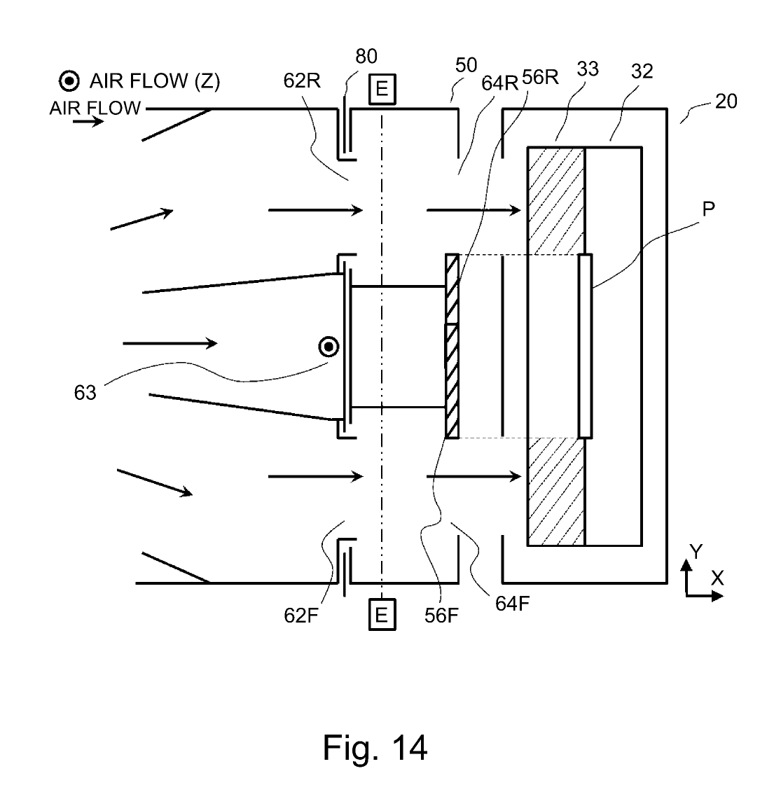

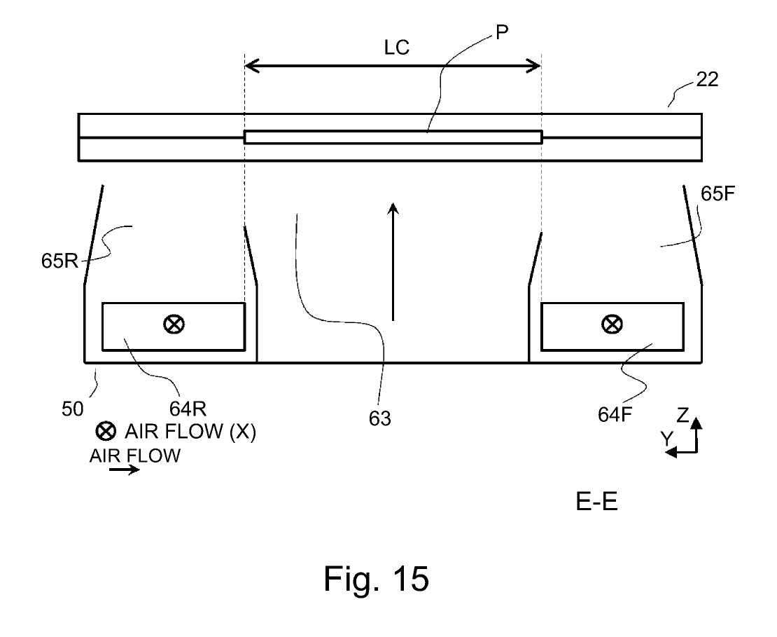

Next, a case in which the front opening 64F and rear opening 64R are fully open is described. FIG. 14 is a schematic sectional view of a combination of the fixation mechanism portion 20, shutter unit 50, and the upstream portion of the delivery tray 75, in terms of the recording medium conveyance direction, at a horizontal plane which is perpendicular to the direction Z, when the shutter is open by the amount for accommodating a postal envelop fed in the landscape mode (when sheet of recording medium is 165 mm in width). FIG. 15 is a schematic sectional view of the combination, at a plane E-E in FIG. 14.

Referring to FIG. 14, the airflow for cooling the front end portion of the fixing member, in terms of the lengthwise direction, is described. As the cooling air is blown into the delivery tray 75 by the cooling fan 53 (FIG. 1), it is sent to the shutter unit 50 through the front opening 62F of the delivery tray 75. The front shutter 56F is fully open. Thus, as the cooling air is sent into the shutter unit 50, all of it flows to the out-of-sheet-path portions of the film 33, which are higher in temperature than the sheet-path portion of the film 33. The path of the airflow for cooling the rear end portion of the fixing member in terms of the lengthwise direction, is symmetrical to the path of the airflow for cooling the front end portion of the fixing member in terms of the lengthwise direction.

Further, the body of cooling air, which flows through the center opening 63, is not affected by the shutter opening. Therefore, it flows toward the sheet P of recording medium as described above. Thus, it is only the body of cooling air which is discharged through the center opening 63, as shown in FIG. 15, that cools a sheet P of recording medium when the sheet P is an postal envelop and is conveyed in the landscape attitude.

Referring to FIG. 15, the area LC which is cooled by the body of air discharged from the center opening 63, is set to be the same in width as the area between the front opening 64F and rear opening 64R when the two openings 64F and 64R are fully open (exposed). Therefore, the body of cooling air which is discharged through the center opening 63 can cool the sheet P of recording medium (postal envelop) across its entire range in terms of the widthwise direction. In this case, the width of the area LC is 165 mm (LC=165 mm). Further, in a case where recording medium is a small sheet of paper (when a postcard is conveyed in portrait attitude (100 mm in widthwise direction), for example), LC>100 mm. Therefore, the recording medium can be cooled across its entire range in terms of the widthwise direction.

In this embodiment, the area in terms of the widthwise direction, across which recording medium can be cooled by the body of air which is discharged from the second outlet, is not narrower than the area, in terms of the lengthwise direction of the fixing member, across which the fixing member is not cooled by the first outlet when the blocking member is fully open.

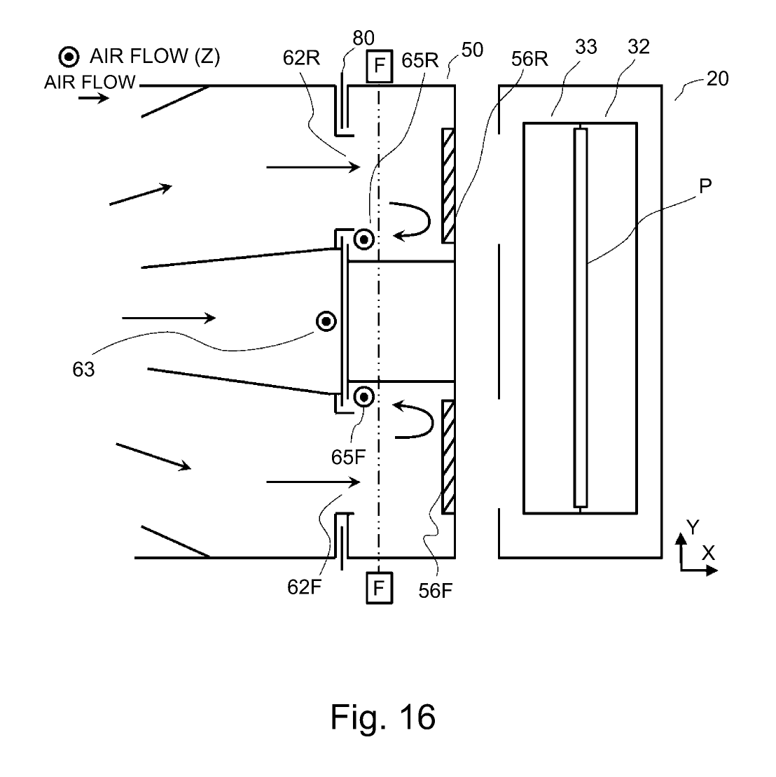

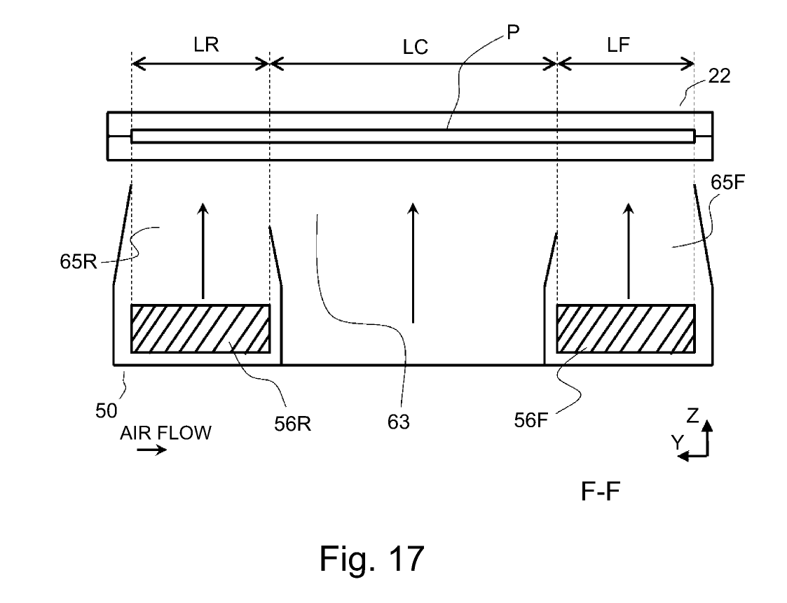

Next, a case in which the front opening 64F and rear opening 64R are remaining completely closed is described. FIG. 16 is a schematic sectional view of a combination of the fixation mechanism portion 20, shutter unit 50, and the upstream end portion of the delivery tray 75 in terms of the recording medium conveyance direction, at a plane which is perpendicular to the direction Z, when a sheet of recording medium (which is 320 mm in width) of a size SRA3 is conveyed in the portrait mode. FIG. 17 is a schematic sectional view of the combination at a plane F-F in FIG. 16. Referring to FIGS. 16 and 17, the flow of the body of air for cooling the front end portions of the film 33 (first rotational member), as a fixing member, which is on the cooling fan side (FIG. 1), is described.

As cooling air is blown into the delivery tray 75 by the cooling fan 53, it is sent to the shutter unit 50 through the front opening 62F of the delivery tray 75. Since the front shutter 56F is completely closed, the cooling air is entirely blocked by the front shutter 56, and therefore, does not flow toward the film 33. As the cooling air flows, it flows toward the opening 65F (FIG. 11) for cooling a sheet of recording medium as the sheet comes out of the nip between the pair of discharge rollers 22, and then, is blown at the sheet P to cool the sheet P as the sheet P comes out of the nip.

The path of the body of air for cooling the rear end portion of the film 33 (first rotational member) in terms of the lengthwise direction is symmetrical (similar) to the path of the body of air for cooling the front end portion of the film 33. As for the body of cooling air which flows through the center opening 63, it is not affected by the shutter opening, and therefore, flows toward the sheet P.

Referring to FIG. 17, there are three bodies of air, that is, the body of air which is discharged through the center opening 63, body of air which is discharged through the front opening 65F, and body of air which is discharged through the rear opening 65R, that cool a sheet P of recording medium. The shutter unit 50 is structured so that the width of the front opening 65F, and the width of the rear opening 65R, correspond to the widest sheet of recording medium conveyable through the fixing apparatus (image forming apparatus). Therefore, a combination of the bodies of cooling air discharged through the center, rear, and front openings 63, 65F, and 65R, one for one, can cool the sheet P across the entire area of the sheet P. In this case, LF+LR+LC=320 mm.

As described above, in this embodiment, in order to prevent the out-of-sheet-path portions of the fixing members from excessively increasing in temperature, the shutter unit 50 is structured so that the front and rear shutters 56F and 56R, respectively, of the shutter unit 50 are movable to control the flow of cooling air. That is, it is structured so that its front and rear shutters 56F and 56R, respectively, are changeable in position, in terms of the lengthwise direction, to change the shutter unit 50 in the range (cooling range), in terms of the lengthwise direction, in which the cooling air from the cooling fan 53 for cooling the widthwise end portions of a sheet P of recording medium as the sheet P is discharged from the fixing device. More specifically, as the shutter is opened wide (when smaller sheet of recording medium is conveyed), it is reduced in the size of the area for cooling the widthwise end portions of the sheet (area is abolished). On the contrary, when the shutter is small in the size of its opening (when larger size of recording medium is conveyed), the range across which the widthwise end portions of a sheet P of recording medium are cooled is greater.

As described above, this embodiment makes it possible to provide a low-cost mechanism which can cool a sheet of recording medium across the entire range of the sheet, regardless of sheet size, without employing unconventional sensor and/or mechanism. That is, according to this embodiment, only one shutter unit 50 was employed. However, the unit 50 is provided with a pair of shutters which are changeable in position according to recording medium size, being therefore capable of cooling not only the out-of-sheet-path portions of the fixing members, but also, controlling the shutter unit 50 in the cooling range in terms of the lengthwise direction. That is, not only can this embodiment make it possible to prevent the out-of-sheet-path portions of the fixing members from excessively increasing in temperature, but also, efficiently cooling a sheet of recording medium regardless of the size of the sheet in terms of the widthwise direction.

Moreover, the shutter unit 50 was structured so that the cooling air outlet, which is not affected by the shutter opening, is across the center portion of the unit 50, and also, that, in terms of the widthwise direction, the sum of the width of the central opening, front opening, and rear opening becomes the same as the dimension of a sheet of recording medium in terms of the widthwise direction. Therefore, it is possible to uniformly cool a sheet of recording medium across the entirety of the sheet, even if the sheet happens to be of the large size.

### Modification

In the foregoing, the present invention was described with reference to one of the preferable embodiments of the present invention. It is needless to say, however, that the embodiment is not intended to limit the present invention in scope. That is, the present invention is also applicable to image forming apparatuses which are different from the one in the embodiment described above, within the scope of the gist of the present invention.

### Modification 1

In the embodiment described above, the shutter unit 50 was structured so that the cooling air roughly perpendicularly hits a sheet of recording medium as soon as the sheet is discharged by the pair of discharge rollers 22. The embodiment, however, is not intended to limit the present invention in scope in terms of the direction in which the sheet is discharged. For example, in order to cool the sheet for a longer length of time, the shutter unit 50 may be structured so that the cooling air is directed toward the sheet-bearing-surface of the delivery tray 75 to make the cooling air to hit the sheet on the delivery tray 75.

Further, the present invention is also applicable to an image forming apparatus structured to guide the cooling air into the main assembly of the apparatus, in order to ensure that the cooling air hits a sheet of recording medium when the sheet is highest in temperature, that is, right after the sheet comes out of the fixing device.

Further, the shutter may be given curvature, or tapered (in cross-section at plane parallel to sheet on which FIG. 9 is), in order to facilitate the body of cooling air blocked by the shutter to flow to the other openings (center opening, for example) than the abovementioned ones. In such a case, it is possible to change the three sections in the amount (cooling amount) by which cooling air is sent to them from the cooling fan 53, without changing the three section in cooling range in terms of the lengthwise direction in FIG. 13.

That is, the amount by which the cooling air is blocked by the front shutter 56F and rear shutter 56R, and therefore, flows toward the sheet P of recording medium through the front opening 65F and rear opening 65R, reduces. Thus, the amount by which cooling air from the cooling fan 53 is made to flow toward the sheet P through the center opening 63 increases by the amount which is equal to the amount by which cooling air is prevented from flowing toward the sheet P through the openings 65F and 65R.

### Modification 2

In the case of the embodiment described above, the image forming apparatus was provided with a means for obtaining the information regarding the dimension of a sheet P of recording medium in terms of the widthwise direction, so that the shutter unit 50 as an airflow blocking means can be changed in its shutter position in terms of the lengthwise direction, based on the obtained information. However, the means for obtaining the information regarding the dimension of the sheet P in terms of the widthwise direction may be different from the one used in the preceding embodiment. For example, the image forming apparatus may be provided with a means for obtaining the information regarding the temperature of the film 33, to recognize the areas in which the out-of-sheet-path portions of the fixing member undesirably increase in temperature, so that the shutter unit, as the blocking member, can be changed in the size and positioning of its opening in terms of the lengthwise direction.

### Modification 3

In the case of the embodiment described above, the second rotational member was the pressure roller. However, the second rotational member may be in the form of an endless belt like the first rotational member.

### Modification 4

In the case of the embodiment described above, the recording medium was a sheet of paper. However, the embodiment is not intended to limit the present invention in scope in terms of recording medium. Generally speaking, recording medium is a sheet of a substance on which a toner image can be formed by an image forming apparatus. It includes a sheet of ordinary paper, cardstock, thin paper, resin, glossy paper, or OHP film, which has a specific shape, or no specific shape, for example. It includes also a seal, an envelop, a postcard, and the like. By the way, in the case of the embodiment described above, the handling of a sheet P of recording medium was described with the use of such terminologies as “sheet passage, sheet discharge, out-of-sheet-path, and the like,” for convenience sake. However, the embodiment is not intended to limit the present invention in scope in terms of recording medium.

### Modification 5

In the case of the embodiment described above, the fixing apparatus was an apparatus for fixing an unfixed toner image to a sheet of recording medium. However, the embodiment is not intended to limit the present invention in scope in terms of fixing apparatus selection. For example, the present invention is also applicable to an apparatus (which also is referred to as fixing apparatus) for applying heat and pressure to a toner image, which has been temporarily fixed to a sheet of recording medium, in order to improve the toner image in glossiness.

While the present invention has been described with reference to exemplary embodiments, it is to be understood that the invention is not limited to the disclosed exemplary embodiments.

This application claims the benefit of Japanese Patent Application No. 2017-103432 filed on May 25, 2017, which is hereby incorporated by reference herein in its entirety.

What is claimed is:

1. An image forming apparatus comprising:
an image forming portion configured to form an image on a recording material;
a fixing device having a nip configured to fix the image on the recording material while nipping and feeding the recording material carrying the image;
air blowing means configured to feed air for cooling a first area which is an end portion area, with respect to a longitudinal direction of said fixing device, of a fixing member constituting said nip;
a blocking member configured to change a width of an opening through which the air fed by said air blowing means flows;
a first blow portion through which the air fed by said air blowing means toward the opening;
a second blow portion through which the air from said air blowing means toward a second area which is a region in a widthwise direction of the recording material passed through said nip flows; and
a third blow portion through which the air from said air blowing means toward a third area which is closer to an end in the widthwise direction of the recording material passed through said nip flows,
wherein said third blow portion is disposed at a position to take the air blocked by said blocking member.

2. An apparatus according to claim 1, further comprising an air feeding path from said air blowing means to said first blow portion.

3. An apparatus according to claim 1, wherein directions in which the air from said air blowing means flows in said second blow portion and said third blow portion cross a direction in which the air from said air blowing means flows in said first blow portion.

4. An apparatus according to claim 1, wherein said first blow portion is disposed at a position closer to the end in response to the longitudinal direction than said third blow portion.

5. An apparatus according to claim 1, wherein said second area is in a central region in the longitudinal direction.

6. An apparatus according to claim 1, wherein further comprising acquiring means configured to acquire information of a length measured in a widthwise direction of the recording material, wherein said blocking member changes the width in accordance with an output of said acquiring means.

7. An apparatus according to claim 1, further comprising acquiring means configured to acquire information of a temperature of said fixing member, wherein said blocking member changes the width in accordance with an output of said acquiring means.

8. An apparatus according to claim 1, wherein a cooling range by said second blow portion in the widthwise direction is not smaller than a non-cooling range not cooled by said first blow portion in the longitudinal direction of said fixing member when said blocking member does not block the opening.

9. An apparatus according to claim 1, wherein said recording material is fed along a feeding path which approaches said air blowing means at a position after said nip.
